(19) United States
(12) Patent Application Publication
(10) Pub. No.: US 2004/0172406 A1
(43) Pub. Date: Sep. 2, 2004

(54) Method and device for the automated adaptation of SLAs and/or services in a communications network

(75) Inventors: Emmanuel Marilly, Antony (FR); Stephane Betge-Brezetz, Paris (FR); Olivier Martinot, Draveil (FR); Gerard Delegue, Cachan (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/657,160

(22) Filed: Sep. 9, 2003

(30) Foreign Application Priority Data
Sep. 12, 2002 (FR) 02 11 306

(51) Int. Cl. G06F 7/00

(52) U.S. Cl. 707/101

(57) ABSTRACT

A device (2) dedicated to the processing of management data for a communications network (N), representing the use of the resources and/or services within the network, comprises processing means (5) arranged so as to determine, from the management data, primary data representing a state of use of the network by at least one user who has made an SLA with the operator of the network, and then to compare this state of use with ancillary data representing the SLA, so as to determine an action to be undertaken in the event of detection of at least one difference between the primary data and the ancillary data.

The invention concerns the field of communications networks, and more particularly that of the management of the resources and services offered by a communications network.

Many users of communications networks wish to have defined service levels, the operators of these networks making available to them a certain number of service level agreements (or SLAs). However, it frequently happens that the operator of a network finds, by analysing the measurements made on the operating and use parameters of his network, differences between the SLAs desired by his clients, the SLAs accepted by his clients and the actual use of the resources and services by the said clients. Consequently some SLAs do not correspond to the actual requirements of the clients either because these clients have initially overestimated or underestimated their requirements, or because the offers of services by the operator, associated with the SLAs, are not adapted to the requirements of some of his clients.

In order to attempt to remedy this drawback, some companies, such as Proviso, Quallaby or Infovista, have proposed detecting SLA violations resulting from the clients or the operator, and making relatively simple analyses in order to deliver alarms when measured data vary within a chosen interval, such as for example from one week to another or from one day to another. However, such a solution does not make it possible to adapt, in an automated fashion, the service offers and/or the SLAs to the actual requirements of the users of the communications networks.

The aim of the invention is therefore to remedy this drawback.

To this end it proposes a device dedicated to the processing of management data in a communications network, representing the use of the resources and/or services within this network, and comprising processing means capable of determining, from these management data, primary data representing a state of use of the network by at least one user who has made an SLA with the operator of the network, and then comparing this state of use with ancillary data representing the SLA in question, so as to determine an action to be undertaken in the event of the detection of at least one difference between the primary data and the ancillary data.

Here “management data” means data representing at least some of the measured performances of the network such as, for example, the current and old data on the use of its resources and/or services.

Preferentially, the primary data, which define the state of use, represent the use of at least one service of the network and/or some of its resources.

The device according to the invention can comprise many supplementary characteristics which can be taken separately and/or in combination, and in particular its processing means can be arranged so as to:

determine the action to be undertaken from amongst a proposal to modify the SLA made between the user and the operator and/or a proposal to modify the services (or service offers) and/or the resources of the network,

adapt at least some of the SLA modification proposals according to the difference or differences detected,

adapt at least some of the service modification proposals (or service offers) and/or the network resources according to one or more SLA modification proposals, and possibly tertiary data, such as for example data resulting from market studies,

determine at least some of the states of use in the form of use profiles associated with time intervals chosen (for example a week or month), from management data corresponding to this time interval,

determine an action to be undertaken from several states of use associated with different users or a state of use associated with a group of users,

automatically institute an SLA modification when at least one condition is satisfied. Such a condition may, for example, be “the increase in the tariff applied to the user is less than the penalty representing the violation of the SLA by this user”,

make their determinations periodically.

The invention also concerns a device for managing a communication network, such as for example a server of the NMS (“Network Management System”) type, equipped with a processing device of the type presented above.

The invention also relates to a method, dedicated to the processing of management data of a communications network, representing the use of the resources and/or services within the said network, and consisting of determining, from these management data, primary data representing a state of use of the network by at least one user who has made an SLA with the operator of the network, and then comparing this state of use with ancillary data representing the SLA, so as to determine an action to be undertaken in the event of the detection of at least one difference between the primary data and the ancillary data.

The method according to the invention can comprise many supplementary characteristics which can be taken separately and/or in combination, and in particular:

the primary data, which define the state of use, preferably represent the use of at least one service of the network and/or some of its resources,

the action to be undertaken can be determined from amongst a proposal to modify the SLA made between the user and the operator and/or a proposal to modify services (or service offers) and/or resources of the network,

at least some of the SLA modification proposals can be adapted according to the difference or differences detected,

at least some of the service modification proposals (or service offers) and/or network resources may be adapted according to one or more SLA modification proposals, and possibly tertiary data, such as for example data resulting from market studies,

at least some of the states of use can be determined in the form of use profiles associated with chosen time intervals (for example a week or month), from management data corresponding to this time interval,

the action to be undertaken can be determined from several states of use associated with different users or a state of use associated with a group of users,

an SLA modification can be initiated automatically when at least one condition is satisfied. Such a condition may, for example, be “the increase in the tariff applied to the user is less than the penalty representing the violation of the SLA by this user”,

the determinations can be made periodically.

The invention can be implemented in any type of communications network, private or public, and in particular in any Internet/IP, ATM, Frame Relay, SDH and WDM networks.

Other characteristics and advantages of the invention will emerge from an examination of the following detailed description, and the accompanying drawings, in which:

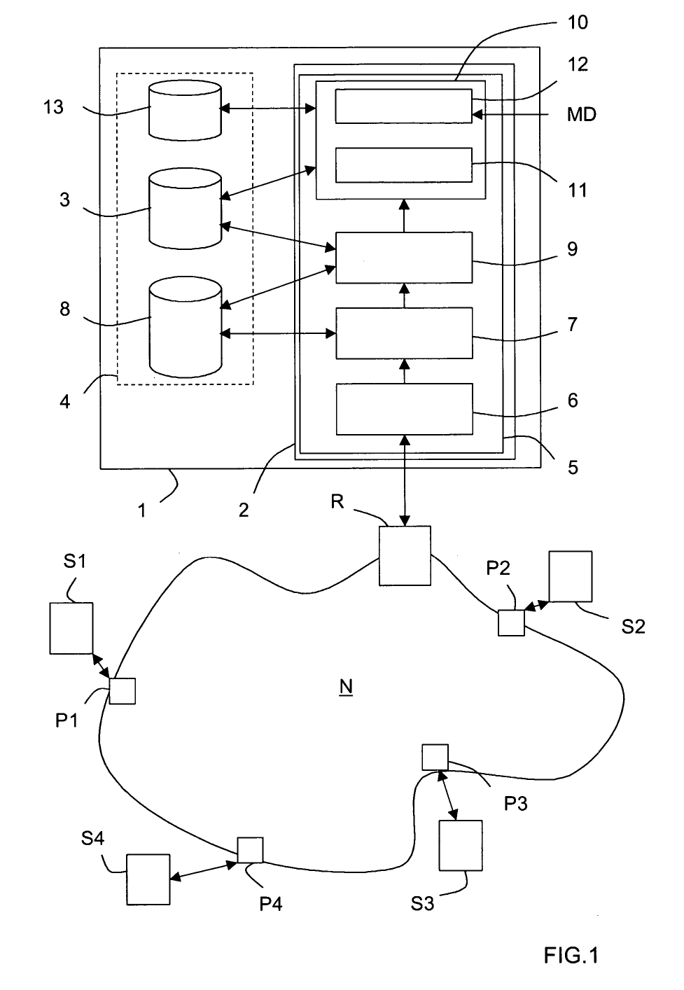

FIG. 1 illustrates schematically part of a communications network equipped with a processing device according to the invention, located in a management server of the network,

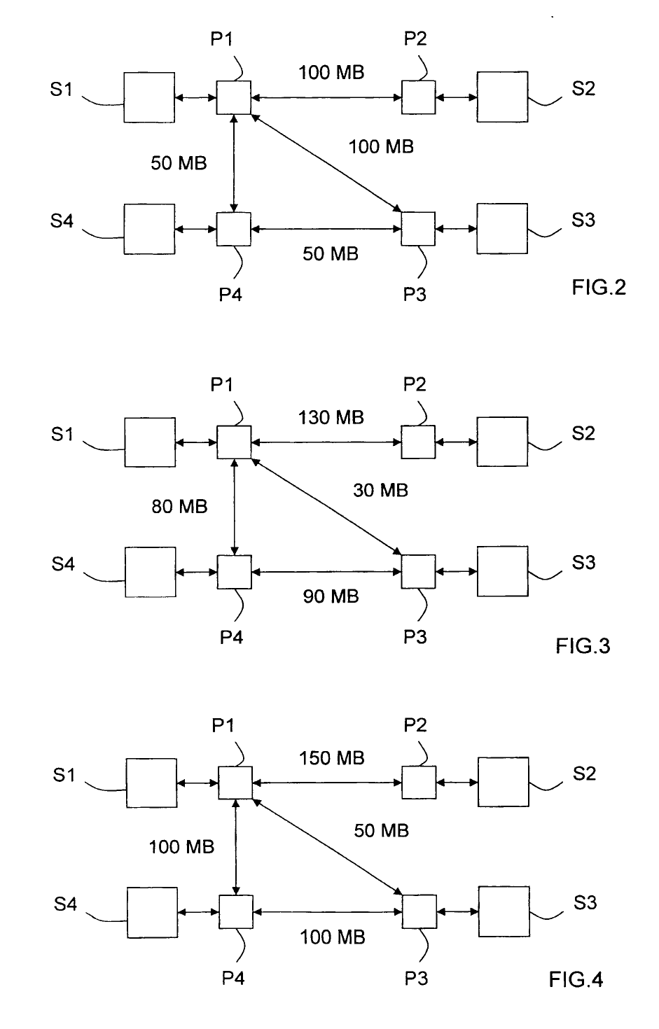

FIG. 2 illustrates schematically an example of a graphical representation of an SLA made between a client having four sites connected together via a virtual private network,

FIG. 3 illustrates schematically an example of a graphical representation of the actual requirements of the client who required the SLA in FIG. 2, and

FIG. 4 illustrates schematically an example of a graphical representation of a modified SLA, adapted to the actual requirements of the client who required the SLA in FIG. 2.

The accompanying drawings can not only serve to supplement the invention, but also contribute to its definition, where applicable.

The processing device according to the invention is intended to be installed in the core of a communications network, of the type illustrated in FIG. 1, for example in a management server of the network 1, of the NMS (“Network Management System”) type, so as to have available measurements of the performance of the network, and in particular measurements of the use of its resources and/or services.

By way of non-limiting example, it is considered hereinafter that the communications network N is the public Internet in which the data are exchanged according to the IP protocol. However, it could be a private network, of the Intranet type, or several public and/or private networks connected to one another. Moreover, it is considered hereinafter that at least some of the users of the network, hereinafter referred to as clients, are bound to the operator of the said network by service level agreements (or SLAS) which include technical parts defined by service level specifications (or SLSs).

A network of the type illustrated in FIG. 1 comprises a multiplicity of core routers R, connected to one another and to the management server NMS 1, directly or indirectly, and edge routers Pi, also referred to as points of presence (or POPs), each connected on the one hand to core routers and on the other hand to terminals and/or servers Sj, belonging in particular to clients of the network.

The management server 1 is fed continuously with management data representing performance measurements of the network, so as to deliver to the manager of the network, via a graphical interface of the GUI type, information on the functioning of his network.

The processing device 2, according to the invention, is intended to compare at least some of the management data coming from the network, in particular those relating to the use of the resources and/or services offered by the said network, with so-called ancillary data representing the SLAs made between the operator and his clients.

Amongst the management data useful for the processing, there can in particular be cited the bandwidths used, the (non-destructive) limitations on traffic (or “traffic shaped”), the (destructive) limitations on traffic (or “traffic dropped”), the delays, the jitter or the packet loss levels (for example on IP).

The ancillary data are preferentially stored in a first part 3 of a database 4 of the management server NMS 1, in correspondence with the corresponding client or clients. However, they could be stored in another item of equipment in the network accessible to the management server NMS 1.

In order to make this comparison, the processing device 2 comprises a processing module 5 comprising first of all a collection module 6 responsible for recovering the network management data necessary for the processing (mentioned above). Such a collection module 6 can, for example, consist of a product sold by the companies Proviso, Quallaby or Infovista.

The processing module 5 also comprises an extraction module 7, supplied with management data by the collection module 6 and responsible for determining, from these management data, so-called primary data representing a state of use of the network by at least one user who has made an SLA with the network operator.

Preferentially, the state of use is in the form of a service usage profile (or SUP). Such an SUP can consist of a set of data or an invariant base line, consisting of primary data which identify and characterise the use which a client or group of clients is actually making of the network, and more precisely at least one of its services or SLAs. These SUPs (or usage profiles) can be obtained by means of an analysis (for example a statistical or correlation analysis) of the measurements which have just been made in the network, as well as possibly older measurements and/or old SUPs (historical) in order to take into account, for example, the change in usage and/or the invariance of a profile. These old measurements, just like the user profiles (or SUPs) determined by the extraction module 7, are preferably stored in a second part 8 of the database 4, in correspondence with a time marking and the corresponding client or clients.

The user profiles (or SUPs) are therefore models which make it possible to study and analyse the behaviour of the client or group of clients, and in particular to reply to behavioural questions “what”, “which”, “when” and “how”. They can also be used for planning modifications to the network and to target and/or analyse market studies better.

The processing module 5 also comprises a comparison module 9, supplied with primary data defining the user profiles (or SUPs), by the extraction module 7 and/or the second part 8 of the database 4, and responsible for comparing the primary data of each SUP, received or extracted from the database 4, with the ancillary data defining the SLA which corresponds to it and which are stored in the first part 3 of the database 4. The comparison can be made, for example, by means of statistical or correlation techniques.

If the result of the comparison shows that the SUP analysed corresponds substantially to the SLA extracted, then the comparison module 9 signifies this to the processing module 5 and the processing of the SUP ends. It is then possible to proceed with the extraction of a new profile. On the other hand, if the result of the comparison shows that the SUP analysed does not correspond to the SLA extracted, then the comparison module 9 indicates this to an adaptation module 10 of the processing module 5. More precisely, the comparison module 9 preferentially transmits to the adaptation module 10 the identifier of the client as well as the SUP determined and/or the data representing the differences between the said SUP and the corresponding SLA.

Provided with this information, the adaptation module 10 can then determine the action to be undertaken in order to remedy the difference or differences detected between the primary data and the ancillary data. For this purpose it has two sub-modules. A first sub-module 11 is responsible for adapting the SLAs, whilst a second sub-module 12 is responsible for adapting the service offers. In both cases, the adaptation is intended to best satisfy the actual requirements of the user or group of users, determined by the extraction module 7 and defined by the user profile or SUP.

Preferentially, the adaptation module 10 asks the first sub-module 11 to produce an SLA adaptation proposal when the difference detected can be taken into account by the service offers of the operator and/or when the number of differences detected is below a threshold, for example equal to two or three. The data defining the service offers of the operator are preferably stored in a third part 13 of the database 4, accessible to the adaptation module 10.

The SLA adaptation proposal can consist, for example, of modifying the bandwidth of one or more connections between points of presence (Pi) of a virtual network (IP-VPN) designed for the client, or changing the service level (from “gold” to “silver”, or vice versa). The SLA consisting of several other elements, it is also possible to envisage proposing a modification to the delays and/or jitter and/or losses, in particular, but also a modification to the network unavailability time in the event of a fault and/or penalties and/or guarantees and/or security measurements and/or the client information mode, in particular.

According to the configuration of the processing device 2, the SLA adaptation proposal may be either imposed automatically, or presented to the client. The automatic adaptation can for example be decided when at least one condition is satisfied. By way of illustrative example, it is possible to decide to automatically adapt an SLA when this adaptation gives rise to an increase in the tariff applied to the client less than the penalty which this client would have to pay because of the violation of his SLA. It would also be possible to envisage an SLA modification (or adaptation) when the user subscribes to a service which is not compatible with the current SLA. For example, when a user has subscribed to an Internet connection of the bronze type and he wishes to have a voice service on IP, or video on demand, or an application such as, in particular, on-line games (etc), which requires a service of the gold type, his connection may change automatically from the bronze type to the gold type.

However, other SLA modification (or adaptation) conditions or criteria may be envisaged. Thus, when a client is to be privileged, for example with a view to a future contract, or with a view to avoiding a loss of contract, or if he must be compensated because of recent breakdowns, then it is possible to increase the quality of at least one of the parameters of his SLA (for example the bandwidth).

Whenever an SLA adaptation proposal is accepted, the ancillary data which define the modified SLA are stored in the first part 3 of the database 4.

When the difference detected cannot be taken into account by the service offers of the operator and/or when the number of differences detected is greater than the threshold, or when the adaptation module 10 finds that many SUPs associated with different clients all have the same type of difference with the corresponding SLA or SLAS, the said adaptation module 10 instructs the first sub-module 11 to produce a proposal to adapt at least one of the service offers of the operator.

Preferentially, this service offer modification proposal is effected using one or more SLA adaptation proposals, supplied by the first sub-module 11, and possibly external data MD coming, for example, from market studies. Consequently the second sub-module 12 can be acted on by the adaptation module 10 only once the first sub-module 11 has been acted on.

In order to produce its service offer adaptation proposals, the second sub-module 10 can consult the data defining the current and past service offers, stored in the third part 13 of the database 4. Moreover, whenever a service offer adaptation proposal is accepted by the operator, the data which define the modified service offer are stored in the third part 13 of the database 4.

The processing device 2 can function in an automated fashion or at the request of the operator. Moreover, the verifications (or determinations) are preferentially carried out periodically. For example, every week the processing device 2 is responsible for checking, client after client, whether their respective SLAs actually satisfy their requirements. In a variant, when at least some of the SLAs are each associated with groups of clients, the processing device 2 may be responsible for checking every week that each SLA satisfies the requirements of the group of clients with which it is associated. However, the operator can also negotiate a specific periodicity with each of his clients.

The modules 5 to 7 and 9 to 12 which constitute the processing device 1 can respectively be produced in the form of electronic circuits, software (or computer) modules, or a combination of circuits and software.

Reference is now made to FIGS. 2 to 4 to describe an illustrative example of functioning of the processing device 2.

It is considered in this example that a business which is a client of an operator has four sites each having an access server Sj (j=1 to 4) connected to a peripheral server or point of presence Pj. These points of presence Pj are connected to the network N, here of the Internet type, and are configured by the network operator so as to constitute, for the client, a virtual private network, of the IP-VPN type (standing for “Internet Protocol-Virtual Private Network”).

As illustrated in FIG. 2, the client has made a service level agreement (SLA) with the operator in order to have an IP-VPN service between his four access servers Sj. More precisely, according to the SLA, the first connection between the first Pi and second P2 points of presence must have a bandwidth of 100 megabits (MB), the second connection between the first Pi and third P3 points of presence must have a bandwidth of 100 MB, the third connection between the first Pi and fourth P4 points of presence must have a bandwidth of 50 MB, and the fourth connection between the third P3 and fourth P4 points of presence must have a bandwidth of 50 MB.

In this example, the extraction module 7, after having performed the analysis of the measurements of the parameters of the network N, concerning the client, delivers to the comparison module 9a user profile (or SUP) depicted schematically in FIG. 3. More precisely, this profile indicates that the client has used bandwidth of 130 MB on the first connection P1-P2, a bandwidth of 30 MB on the second connection P1-P3, a bandwidth of 80 MB on the third connection P1-P4, and a bandwidth of 90 MB on the fourth connection P3-P4.

The comparison module 9 extracts from the first part 3 of the database 4 the ancillary data which define the SLA of the client, and then compares them with the primary data defining the SUP determined by the extraction module 7. It deduces immediately therefrom that the client is using more bandwidth on three connections and less bandwidth on one connection than is authorised by the SLA. More precisely, on the connection P1-P2 the client has used a bandwidth of 130 MB instead of the 100 MB authorised, on the connection P1-P3 the client has used a bandwidth of 30 MB instead of the 100 MB authorised, on the connection P1-P4 the client has used a bandwidth of 80 MB instead of the 50 MB authorised, and on the connection P3-P4 the client has used a bandwidth of 90 MB instead of the 50 MB authorised.

The comparison module 9 indicates these differences to the adaptation module 10, which then instructs the first sub-module 11 to produce an adaptation of the SLA of the client, having regard to the SUP received which defines its actual requirements.

The first sub-module 11 then examines the service offers of the operator, stored in the third part 13 of the database 4, and finds that they propose bandwidths of 50 MB, 100 MB and 150 MB. It then notes that it is in a position to make a proposal to adapt the SLA of the client, which complies with the service offers of the operator. This proposal is depicted schematically in FIG. 4. It consists of proposing a bandwidth of 150 MB on the first connection P1-P2, a bandwidth of 50 MB on the second connection P1-P3, a bandwidth of 100 MB on the third connection P1-P4, and a bandwidth of 100 MB on the fourth connection P3-P4.

In this example, there is no reason to make the second sub-module 12 function, since the modification of the SLA satisfies the service offers of the operator. Consequently the adaptation module 10 can either propose the modified SLA to the client or automatically initiate this modified SLA, according to the agreements made between the operator and the client.

The invention also offers a method of processing management data of a communications network.

This can be implemented by means of the processing device 2 presented above. The main and optional functions and sub-functions provided by the steps of this method being substantially identical to those provided by the various means constituting the processing device 2, only the steps implementing the main functions of the method according to the invention will be summarised below.

This method consists of determining, from the management data, primary data representing a state of usage of the network N by at least one user who has made an SLA with the network operator, and then comparing this state of usage with ancillary data representing the SLA, so as to determine an action to be undertaken in the event of the detection of at least one difference between the primary data and the ancillary data.

By virtue of the invention, the manager of the network can have available precise information on the actual requirements of his clients, which enables him firstly to better satisfy them since they will pay only for the services which correspond to the requirements, and secondly to manage the network better, and in particular its traffic.

In addition, the invention enables the network manager to adapt his service offers to the actual requirements of his clients.

In addition, the device according to the invention can given information on the future changes in the service offers and on the corresponding resources to be used, for example after a study and analysis of trends.

The invention is not limited to the embodiments of the processing method and device described above, solely by way of example, but encompasses all variants which could be envisaged by a person skilled in the art in the context of the following claims.

What is claimed is:

1. A device (2) for processing management data for a communications network (N), representing the use of the resources and/or services within the said network, characterised in that it comprises processing means (5) arranged so as to determine primary data representing a state of use of the network (N) by at least one user who has made a service level agreement, or “SLA”, with an operator of the said network, from the said management data, and then to compare the said state of use with ancillary data representing the said SLA, so as to determine an action to be undertaken in the event of the detection of at least one difference between the said primary data and the said ancillary data, the said processing means (5) being arranged in order to determine the said action to be undertaken amongst an action group comprising a proposal to modify the SLA made between the said user and the said operator and/or a proposal to modify the services and/or resources of the said network (N), and to adapt at least some of the SLA modification proposals according to the said difference detected.

2. A device according to claim 1, characterised in that the said primary data represent a use of at least one service and/or of resources.

3. A device according to claim 1, characterised in that the said processing means (5) are arranged so as to adapt at least some of the proposals to modify the services and/or resources of the said network according to at least one SLA modification proposal.

4. A device according to claim 3, characterised in that the said processing means (5) are arranged so as to adapt at least some of the proposals to modify the services and/or resources of the said network according to tertiary data (MD).

5. A device according to claim 1, characterised in that the said processing means (5) are arranged so as to determine at least some of the states of use in the form of a usage profile (SUP) in a chosen time interval, from management data corresponding to the said time interval.

6. A device according to claim 1, characterised in that the said processing means (5) are arranged so as to determine an action to be undertaken from several states of use associated with different users or a state of use associated with a group of users.

7. A device according to claim 1, characterised in that the said processing means (5) are arranged so as to automatically initiate an SLA modification when at least one condition is satisfied.

8. A device according to claim 7, characterised in that the said processing means (5) are arranged so as to automatically initiate the said SLA modification when it is associated with an increase in the tariff of the user less than a penalty representing the violation of the SLA by the user.

9. A device according to claim 1, characterised in that the said processing means (5) are arranged so as to make their determinations periodically.

10. A device (1) for managing a communications network (N), characterised in that it comprises a processing device (2) according to one of the preceding claims.

11. A method of processing management data for a communications network (N), representing the use of the resources and/or of the services within the said network, characterised in that it consists of determining primary data representing a state of use of the network (N) by at least one user who has made a service level agreement, or “SLA”, with an operator of the said network, from the said management data, and then comparing the said state of use with ancillary data representing the said SLA, so as to determine an action to be undertaken in the event of the detection of at least one difference between the said primary data and the said ancillary data, the said action to be undertaken is determined in an action group comprising a proposal to modify the SLA made between the said user and the said operator and/or a proposal to modify the services and/or resources of the said network (N), at least some of the SLA modification proposals are adapted according to the said difference detected.

12. A method according to claim 11, characterised in that the said primary data represent a use of at least one service and/or resource or resources.

13. A method according to claim 11, characterised in that at least some of the proposals to modify the services and/or resources of the said network (N) are adapted according to at least one proposal to modify the SLA.

14. A method according to claim 13, characterised in that at least some of the proposals to modify the services and/or resources of the said network are adapted according to tertiary data (MD).

15. A method according to claim 11, characterised in that at least some of the states of use are determined in the form of a usage profile (SUP) in a chosen time interval, from management data corresponding to the said time interval.

16. A method according to claim 11, characterised in that some actions to be undertaken are determined from several states of use associated with different users or a state of use associated with a group of users.

17. A method according to claim 11, characterised in that an SLA modification is instituted automatically when at least one condition is satisfied.

18. A method according to claim 17, characterised in that the said SLA modification is instituted when it is associated with an increase in the tariff of the user less than a penalty representing the violation of the SLA by the user.

19. A method according to claim 11, characterised in that the determinations are made periodically.

20. Use of the method, processing device (2) and management device (1) according to one of the preceding claims in networks chosen from a group comprising Internet (IP), ATM, Frame Relay, SDH and WDM networks.
